(19) United States
(12) Patent Application Publication
(10) Pub. No.: US 2025/0344878 A1
(43) Pub. Date: Nov. 13, 2025

(54) Multi-Functional Baby Product Attachment System with Automated Swinging Mechanism

(71) Applicant: Shane Kirk, Riverside, CA (US)

(72) Inventor: Shane Kirk, Riverside, CA (US)

(21) Appl. No.: 18/658,034

(22) Filed: May 8, 2024

(51) Int. Cl. A47D 9/04; A47D 9/02; G06F 3/16; G08C 17/02; H04W 4/80

(52) U.S. Cl. CPC A47D 9/04; A47D 9/057; G06F 3/165; G08C 17/02; H04W 4/80

(57) ABSTRACT

The present invention is a multi-functional baby product attachment system that integrates an automated swaying mechanism, music playback, Bluetooth connectivity, adjustable night lights, and phone charging capabilities into a compact, versatile device. The invention aims to provide a comprehensive solution for soothing and entertaining babies while attached to various baby products such as strollers, car seats, bassinets, and cribs.

### BACKGROUND

The present invention relates to baby products and accessories, particularly to a multi-functional attachment system for strollers, car seats, bassinets, and cribs.

Parents and caregivers often struggle to soothe and entertain babies, particularly when away from home or during travel. Babies may become fussy or agitated in unfamiliar environments or when experiencing discomfort. Various solutions have been proposed to address these challenges, but they often fall short in terms of versatility, ease of use, and range of features.

For example, U.S. Pat. No. 9,635,949 to Bdeir et al. discloses a crib mobile with a phone charging station, speakers, and the ability to play audio from a connected device. While useful for cribs, this solution is not easily adaptable to other baby products like strollers or car seats. Additionally, it lacks features such as an automated swaying mechanism and adjustable night lights, which could further enhance its soothing capabilities.

Another example, U.S. Pat. No. 8,499,898 to Leyden et al., describes a baby stroller with a built-in charging system for electronic devices. It includes a generator connected to the stroller wheels to charge a removable electronic device, which can play music or video. However, this system is limited to strollers and does not offer a comprehensive set of features to soothe and entertain the baby.

While these and other existing solutions provide some benefits, there remains a need for a versatile, feature-rich system that can be easily used with various baby products. Such a system should offer a range of capabilities, including automated swaying motions, music playback, adjustable lighting, and convenient phone charging. Ideally, it would be designed for intuitive operation and adaptability to different environments and baby product styles. By integrating these features into a user-friendly, compact package, a multi-functional attachment system could significantly alleviate the challenges faced by parents and caregivers in soothing and entertaining babies on the go.

By combining these features into a single, user-friendly attachment system, the present invention offers a significant advancement over prior art solutions, which often lack versatility and a comprehensive set of soothing and entertainment functions. The invention's unique integration of an automated swaying mechanism, music playback, Bluetooth connectivity, night lights, and phone charging addresses the need for a more effective and adaptable solution to the challenges faced by parents and caregivers in calming and engaging babies on the go.

### SUMMARY

The present invention is a multi-functional baby product attachment system that integrates an automated swaying mechanism, music playback, Bluetooth connectivity, adjustable night lights, and phone charging capabilities into a compact, versatile device. The invention aims to provide a comprehensive solution for soothing and entertaining babies while attached to various baby products such as strollers, car seats, bassinets, and cribs.

The attachment system comprises a swaying mechanism that generates a gentle rocking motion, a music playback system with internal storage and streaming capabilities, a Bluetooth connectivity module for streaming audio from smartphones, adjustable LED night lights, a USB charging port for mobile devices, and a versatile bracket system for tool-free attachment to different baby products. These components are housed in a compact unit powered by rechargeable batteries or a wired connection.

The swaying mechanism includes a motor, a drive shaft, and an adjustable linkage assembly that converts the motor's rotational motion into a reciprocating motion, creating a soothing rocking effect. The music playback system features an audio processor, memory for storing audio files, and speakers for outputting sound. The Bluetooth module allows users to stream personalized audio content from their smartphones or other devices. The LED night lights provide gentle illumination with adjustable brightness, while the USB port enables convenient charging of mobile devices.

The attachment system is designed for ease of use, with intuitive controls for activating and adjusting the various features. The versatile bracket system ensures compatibility with a wide range of baby product styles and sizes, allowing parents and caregivers to use the device in multiple settings.

### BRIEF DESCRIPTION OF THE DRAWINGS

FIG. 1 illustrates the rocker according to the present invention.

### DETAILED DESCRIPTION

The various exemplary embodiments of the present invention, which will become more apparent as the description proceeds, are described in the following detailed description in conjunction with the accompanying drawings.

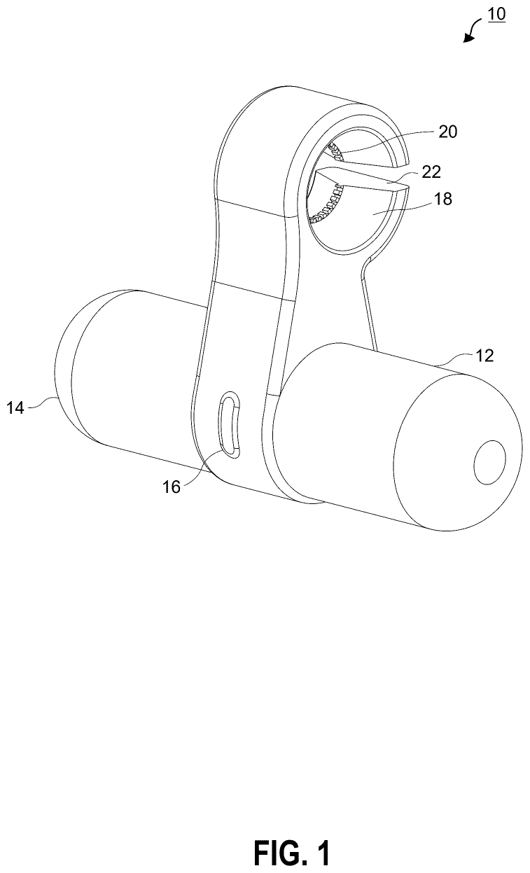

FIG. 1 illustrates the rocker 10 according to the present invention.

Connector 18 connects to a stroller and automatically rocks the stroller according to parameters set in a control unit for rocker 10, which could also be associated with a mobile device application.

Connector 18 comprises first adjuster piece 22 and second adjuster piece 20. First adjuster piece 22 and second adjuster piece 20 can fit a variety of sizes of stroller bars by expanding and contracting around the stroller bar for a tight fit. A series of teeth can be provided to achieve a tight fit around a stroller bar, car seat, or other baby product.

Speaker 14 is an audio speaker which can be connected to a mobile device, for example via Bluetooth. Body 12 can contain a USB charging port to charge an internal battery associated with the rocker 10. In some embodiments, rocker 10 may connect to a wall outlet.

Interface 16 can be used to manually increase or decrease the speed of the automatic rocking and/or the volume of the sound coming from the speaker 14.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An automated baby product rocking system comprising:
a motor, a drive shaft, and an adjustable linkage assembly that converts the motor's rotational motion into a reciprocating motion for a swaying mechanism configured to provide an adjustable gentle rocking motion to a baby product, wherein the baby product is one of a stroller, car seat, bassinet, or crib;
an adjustable connector to the baby product;
a control unit;
a music playback system configured to play soothing sounds and melodies from internal storage or streamed audio content;
a Bluetooth connectivity module in communication with the music playback system, configured to wirelessly stream audio content from a Bluetooth-enabled device;
one or more night lights configured to provide adjustable gentle illumination;
a phone charging port configured to recharge a mobile device; and
a versatile bracket system configured to removably attach the multi-functional baby product attachment system to the baby product without tools;
wherein the swaying mechanism, music playback system, Bluetooth connectivity module, one or more night lights, and phone charging port are integrated into a compact housing attached to the baby product via the versatile bracket system, and wherein the multi-functional baby product attachment system is powered by one of a rechargeable battery or a wired connection.

2. The system of claim 1, wherein the control unit is connected to an external electronic device.

3. The system of claim 2, further comprising a speed control module in the control unit in communication with the motor, configured to adjust a speed of the motor to vary the rocking motion.

4. The system of claim 1, wherein the music playback system comprises:
an audio processor;
a memory storing audio files coupled to the audio processor; and
at least one speaker coupled to the audio processor for audio output.

5. The system of claim 4, further comprising user controls coupled to the audio processor, configured to allow user selection of audio files and adjustment of playback settings.

6. The system of claim 1, wherein the Bluetooth connectivity module comprises a Bluetooth transceiver configured to pair with a Bluetooth-enabled device and receive streaming audio data.

7. The system of claim 1, wherein the one or more night lights comprise light emitting diodes (LEDs).

8. The system of claim 7, further comprising a dimmer module coupled to the LEDs, configured to adjust a brightness level of the LEDs.

9. The system of claim 1, wherein the phone charging port comprises a Universal Serial Bus (USB) port.

10. The system of claim 1, wherein the versatile bracket system comprises:
a first bracket member configured to attach to the compact housing; and
a second bracket member configured to removably attach to the baby product and mate with the first bracket member.

11. The system of claim 10, wherein the second bracket member is adjustable to fit a plurality of different baby product styles and sizes.

12. The system of claim 1, further comprising a battery compartment configured to hold the rechargeable battery.

14. The system of claim 1, further comprising a power supply circuit configured to select between the rechargeable battery and the wired connection as a power source.

15. The system of claim 1, further comprising a wireless remote control configured to remotely operate the swaying mechanism and the music playback system.

16. A method for soothing a baby using a multi-functional baby product attachment system, the method comprising:
removably attaching the multi-functional baby product attachment system to a baby product via a versatile bracket system without tools, wherein the baby product is one of a stroller, car seat, bassinet, or crib;
activating a swaying mechanism to provide an adjustable gentle rocking motion to the baby product;
playing soothing sounds and melodies from internal storage or streamed audio content via a music playback system;
wirelessly streaming personalized audio content from a Bluetooth-enabled device to the music playback system via a Bluetooth connectivity module;
providing adjustable gentle illumination via one or more night lights (4); and
recharging a mobile device via a phone charging port;
wherein the swaying mechanism, music playback system, Bluetooth connectivity module, one or more night lights, and phone charging port are integrated into a compact housing attached to the baby product via the versatile bracket system, and wherein the multi-functional baby product attachment system is powered by one of a rechargeable battery or a wired connection.

17. The method of claim 16, wherein activating the swaying mechanism comprises:
operating a motor to rotate a drive shaft; and
converting rotational motion of the drive shaft into an adjustable gentle rocking motion.

18. The method of claim 16, wherein playing soothing sounds and melodies comprises:
processing audio files via an audio processor;
retrieving the audio files from a memory coupled to the audio processor; and
outputting audio via at least one speaker coupled to the audio processor.

19. The method of claim 16, wherein removably attaching the multi-functional baby product attachment system comprises:
attaching a first bracket member to the compact housing; and
removably attaching a second bracket member to the baby product, the second bracket member configured to mate with the first bracket member.

20. The method of claim 19, further comprising adjusting the second bracket member to fit the baby product, wherein the second bracket member is adjustable to fit a plurality of different baby product styles and sizes.
